(19) United States
(12) Patent Application Publication
(10) Pub. No.: US 2019/0101466 A1
(43) Pub. Date: Apr. 4, 2019

(54) System and Method of Sensing Pressure Within a Pipe

(71) Applicant: CDI Meters, Inc., Woburn, MA (US)

(72) Inventor: Roger E. Dennison, Lexington, MA (US)

(21) Appl. No.: 16/143,663

(22) Filed: Sep. 27, 2018

Related U.S. Application Data
(60) Provisional application No. 62/567,381, filed on Oct. 3, 2017.

(51) Int. Cl. G01L 19/00; G01F 1/684; G01L 19/06

(52) U.S. Cl. CPC G01L 19/0092; G01L 19/147; G01L 19/0672; G01F 1/684

(57) ABSTRACT

A system and method of sensing pressure in a device that seals against the outside of a pipe and has a probe projecting into the pipe.

### CROSS-REFERENCE TO RELATED APPLICATION

This application claims priority of Provisional Patent Application 62/567,381 filed on Oct. 3, 2017.

### BACKGROUND

Flowmeters are sometimes constructed to seal to the outside of a pipe with a probe projecting into the pipe. It may be desired to sense pressure in addition to flow, and it may not be convenient to communicate the pressure through the probe.

### SUMMARY

A system and method that provides for the communication of pressure in a pipe to a pressure sensor mounted within a flowmeter that is sealed to the outside of the pipe with a probe projecting through a hole into the pipe, where that probe is not suitable for communicating pressure to the pressure sensor. The seal against the pipe is formed in such a way as to create a passage along the outside of the pipe to communicate pressure from within the pipe to the pressure sensor.

All examples and features mentioned below can be combined in any technically possible way.

In one aspect, a system for sensing pressure in a pipe includes a pressure sensor mounted within a flowmeter that is located outside and proximate a pipe, where the flowmeter comprises a probe projecting through a hole in the pipe and into the pipe, and a sealing structure between the flowmeter and the pipe, where the sealing structure and pipe are arranged to define a passage along the outside of the pipe, wherein the passage fluidly communicates with the hole and the pressure sensor, such that pressure in the pipe is communicated to the pressure sensor. Embodiments may include one of the above and/or below features, or any combination thereof. The sealing structure may comprise a gasket that surrounds the hole in the pipe. The pressure sensor may be spaced from the probe. The gasket may comprise an elongated cutout that defines the passage. The flowmeter may be mounted to the pipe by a mounting structure, which may be a split ring. The pressure sensor may be located at least in part in a cavity in the mounting structure. The cavity may be open to the passage. The pressure sensor may be located in the opening of the cavity into the passage. The system may also include a seal that is configured to seal the pressure sensor to the mounting structure to inhibit fluid from leaking past the seal into the cavity.

In another aspect, a method of sensing pressure in a pipe to which a device is sealed with a probe entering the pipe through a hole includes locating a seal between the device and the pipe, wherein the seal, the device, and the pipe together are configured to create a passage along the pipe though which pressure from inside the pipe can communicate with a pressure sensor outside of the pipe.

### BRIEF DESCRIPTION OF THE DRAWINGS

Other objects, features and examples will occur to those skilled in the art from the following description and the accompanying drawings, in which:

FIG. 1 is a sectional view showing a portion of a flowmeter sealed against a pipe.

FIG. 2 is an angled view of one example of a flowmeter for the present disclosure.

### DETAILED DESCRIPTION

This disclosure pertains to systems and methods of sensing pressure within a pipe. A flowmeter is sealed to the outside of the pipe and has a probe projecting into the pipe through a drilled hole. A pressure sensor is mounted within the flowmeter. The seal against the pipe is formed in such a way as to create a passage along the outside of the pipe to communicate pressure from within the pipe to the pressure sensor.

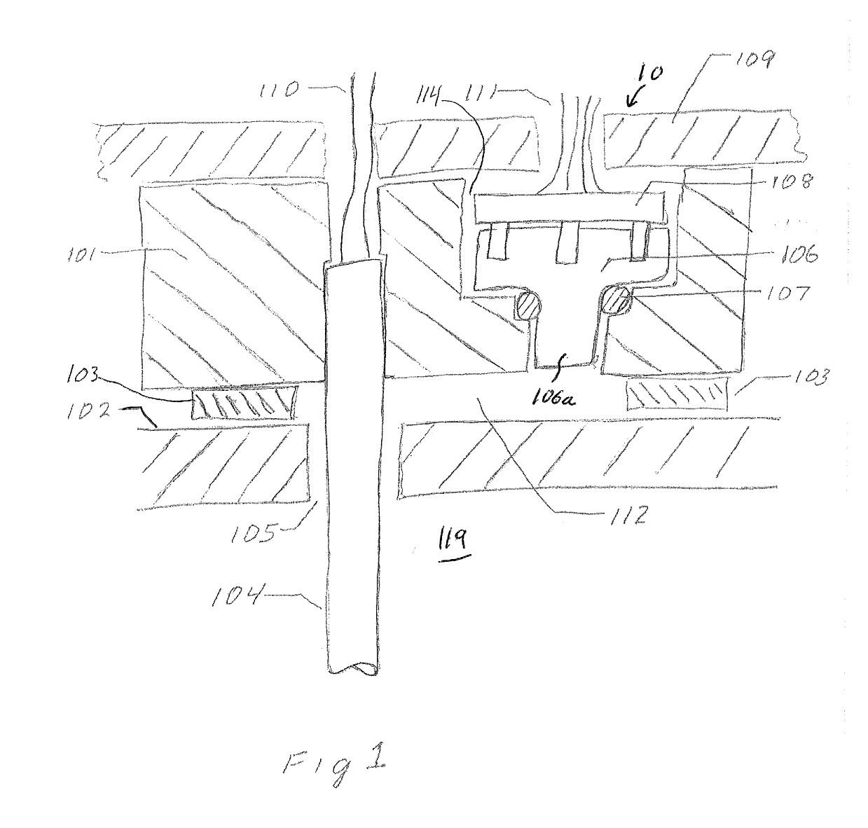

FIG. 1 shows elements of flowmeter 10. A split ring, 101, mounts to the outside of pipe wall 102 and seals to it by means of gasket 103. Probe 104, which might be a flow-sensing or temperature-sensing probe, enters the pipe through pipe wall hole 105 and so is exposed to fluid in pipe interior 119. Pressure sensor 106 mounts within a cavity 114 in the split ring and seals to the ring by means of o-ring 107. The pressure sensor is mounted on a small circuit board 108 that is held in place by screws (not shown). The drawing also shows the underside of the electronic enclosure 109 and wiring 110, 111 from the probe and the pressure sensor, respectively, to the electronics (not shown). Note that flowmeter could be mounted to a different structure or housing. Also, the pressure sensor can be part of the flowmeter, or it could be separate from but proximate the flowmeter in an arrangement such that passage 112 leads from the hole in the pipe for the flowmeter probe to the pressure sensor.

Gasket 103 is shaped in such a way as to form a passage 112 (which in this case is a gap between the pipe wall and the split ring) along the outside of the pipe from the hole in the pipe to the pressure sensor, which has pressure sensing portion 106a exposed to passage 112. Pressure sensing portion 106a is thus exposed to the fluid in the pipe and so is able to detect the fluid pressure.

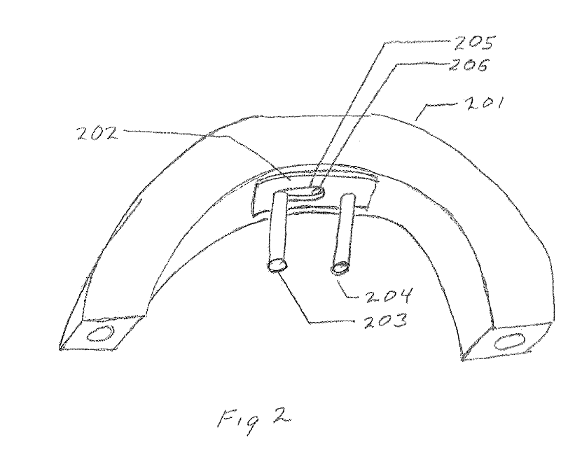

FIG. 2 illustrates an exemplary flowmeter in which two flowmeter probes are mounted in a single ring. This is a thermal-type flowmeter where one probe senses the air temperature and the other probe is heated ten degrees above the air temperature to sense flow. Half ring 201 bolts to a second half ring (not shown) clamping around a pipe (not shown). Gasket 202 is compressed against the pipe, forming a seal. Two probes, 203 and 204, enter the pipe through drilled holes. Elongated cutout 205 in gasket 202 forms a path from the hole in the pipe through which probe 203 enters to cavity 206, in which the port of the pressure sensor (not shown) is located.

The system and method of sensing pressure within a pipe avoids the need to drill a separate hole in the pipe to sense pressure, or to have a probe conduct pressure to the pressure sensor. The flowmeter can be mounted to the pipe in any manner; a split ring is simply one non- limiting example of such mounting. Also, the flowmeter can have one probe, or more than one probe.

A number of implementations have been described. Nevertheless, it will be understood that additional modifications may be made without departing from the scope of the inventive concepts described herein, and, accordingly, other embodiments are within the scope of the following claims.

What is claimed is:

1. A system for sensing pressure in a pipe, comprising:
a pressure sensor mounted within a flowmeter that is located outside and proximate a pipe, where the flowmeter comprises a probe projecting through a hole in the pipe and into the pipe; and
a sealing structure between the flowmeter and the pipe, where the sealing structure and pipe are arranged to define a passage along the outside of the pipe, wherein the passage fluidly communicates with the hole and the pressure sensor, such that pressure in the pipe is communicated to the pressure sensor.

2. The system of claim 1, wherein the sealing structure comprises a gasket that surrounds the hole in the pipe.

3. The system of claim 2, wherein the pressure sensor is spaced from the probe, and wherein the gasket comprises an elongated cutout that defines the passage.

4. The system of claim 1, wherein the flowmeter is mounted to the pipe by a mounting structure.

5. The system of claim 4, wherein the pressure sensor is located at least in part in a cavity in the mounting structure.

6. The system of claim 5, wherein the cavity is open to the passage.

7. The system of claim 6, wherein the pressure sensor is located in the opening of the cavity into the passage.

8. The system of claim 7, further comprising a seal that is configured to seal the pressure sensor to the mounting structure to inhibit fluid from leaking past the seal into the cavity.

9. A method of sensing pressure in a pipe to which a device is sealed with a probe entering the pipe through a hole, comprising:
locating a seal between the device and the pipe, wherein the seal, the device, and the pipe together are configured to create a passage along the pipe though which pressure from inside the pipe can communicate with a pressure sensor outside of the pipe.
